(19) United States
(12) Patent Application Publication
(10) Pub. No.: US 2012/0156481 A1
(43) Pub. Date: Jun. 21, 2012

(54) FUSER MEMBER AND COMPOSITION

(75) Inventors: Carolyn P. Moorlag, Mississauga (CA); Yu Qi, Oakville (CA); Qi Zhang, Mississauga (CA); Nan-Xing Hu, Oakville (CA); Kurt I. Halfyard, Mississauga (CA); Nicoleta D. Mihai, Oakville (CA); Gordon Sisler, St. Catharines (CA); Guiqin Song, Milton (CA); Edward G. Zwartz, Mississauga (CA); T. Brian McAneney, Burlington (CA)

(73) Assignee: XEROX CORPORATION, Norwalk, CT (US)

(21) Appl. No.: 12/974,836

(22) Filed: Dec. 21, 2010

(51) Int. Cl. C08G 77/24; B32B 27/08

(52) U.S. Cl. 428/339; 528/36; 528/34; 428/448; 428/447

(57) ABSTRACT

The present teachings provide a fuser member. The fuser includes a layer of a siloxyfluorocarbon networked polymer.

### CROSS REFERENCE TO RELATED APPLICATIONS

This application relates to commonly assigned copending application Ser. No. (Docket 20100635-US-NP, XRX-0027), FUSER MEMBER, filed simultaneously herewith and incorporated by reference herein.

### BACKGROUND

1. Field of Use

This disclosure is generally directed to fuser members useful in electrophotographic imaging apparatuses, including digital, image on image, and the like. In addition, the fuser member described herein can also be used in a transfix apparatus in a solid ink jet printing machine.

2. Background

In the electrophotographic printing process, a toner image can be fixed or fused upon a support (e.g., a paper sheet) using a fuser roller. Conventional fusing technologies apply release agents/fuser oils to the fuser roller during the fusing operation, in order to maintain good release properties of the fuser roller. For example, oil fusing technologies have been used for all high speed products in the entry production and production color market.

Extending oil-less fusing technologies to high speed printers, such as 100 pages per minute (ppm) or faster, while meeting a series of stringent system requirements such as image quality, parts cost, reliability, long component life, etc. remains technically challenging.

While perfluoroalkoxy polymer resin (PFA) is currently used in many topcoat formulations in fuser rollers and belts to yield excellent release, issues such as surface cracking, denting, and delamination limit the lifetime of PFA rollers and belts. It would be desirable to find a material combination for fuser rollers and belts that mitigates surface cracking, denting and delamination while providing excellent release. In addition, adhesion between the intermediate layers and outer layer can be a problem when using a PFA outer layer. It would be desirable to find a material combination that eliminates the need for adhesion or primer layers.

### SUMMARY

According to an embodiment, a fuser member is provided. The fuser member includes a layer of a siloxyfluorocarbon networked polymer.

According to another embodiment, there is disclosed a method for producing a polymer comprising reacting in a solution of siloxane terminated fluorocarbons, and a solvent to form a networked siloxyfluorocarbon. The siloxyfluorocarbon networked polymer has a fluorine content of between about 30 weight percent to about 70 weight percent.

According to another embodiment there is provided a fuser member. The fuser member includes a substrate and a resilient layer disposed on the substrate. An adhesive layer comprising a networked siloxyfluorocarbon polymer is disposed on the resilient layer. A release layer comprising a fluoropolymer is disposed on the adhesive layer.

### BRIEF DESCRIPTION OF THE DRAWINGS

The accompanying drawings, which are incorporated in and constitute a part of this specification, illustrate several embodiments of the present teachings and together with the description, serve to explain the principles of the present teachings.

FIG. 1 depicts an exemplary fusing member having a cylindrical substrate in accordance with the present teachings.

FIG. 2 depicts an exemplary fusing member having a belt substrate in accordance with the present teachings.

FIGS. 3A-3B depict exemplary fusing configurations using the fuser rollers shown in FIG. 1 in accordance with the present teachings.

FIGS. 4A-4B depict another exemplary fusing configurations using the fuser belt shown in FIG. 2 in accordance with the present teachings.

FIG. 5 depicts an exemplary fuser configuration using a transfix apparatus.

It should be noted that some details of the FIGS. have been simplified and are drawn to facilitate understanding of the embodiments rather than to maintain strict structural accuracy, detail, and scale.

### DESCRIPTION OF THE EMBODIMENTS

Reference will now be made in detail to embodiments of the present teachings, examples of which are illustrated in the accompanying drawings. Wherever possible, the same reference numbers will be used throughout the drawings to refer to the same or like parts.

In the following description, reference is made to the accompanying drawings that form a part thereof, and in which is shown by way of illustration specific exemplary embodiments in which the present teachings may be practiced. These embodiments are described in sufficient detail to enable those skilled in the art to practice the present teachings and it is to be understood that other embodiments may be utilized and that changes may be made without departing from the scope of the present teachings. The following description is, therefore, merely exemplary.

Illustrations with respect to one or more implementations, alterations and/or modifications can be made to the illustrated examples without departing from the spirit and scope of the appended claims. In addition, while a particular feature may have been disclosed with respect to only one of several implementations, such feature may be combined with one or more other features of the other implementations as may be desired and advantageous for any given or particular function. Furthermore, to the extent that the terms “including”, “includes”, “having”, “has”, “with”, or variants thereof are used in either the detailed description and the claims, such terms are intended to be inclusive in a manner similar to the term “comprising.” The term “at least one of” is used to mean one or more of the listed items can be selected.

Notwithstanding that the numerical ranges and parameters setting forth the broad scope of embodiments are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein. For example, a range of “less than 10” can include any and all sub-ranges between (and including) the minimum value of zero and the maximum value of 10, that is, any and all sub-ranges having a minimum value of equal to or greater than zero and a maximum value of equal to or less than 10, e.g., 1 to 5. In certain cases, the numerical values as stated for the parameter can take on negative values. In this case, the example value of range stated as “less than 10” can assume negative values, e.g. −1, −2, −3, −10, −20, −30, etc.

The fixing member can include a substrate having one or more functional layers formed thereon. The substrate can include, e.g., a cylinder or a belt. The one or more functional layers includes an outermost or top silicon textured surface having a surface wettability that is hydrophobic and/or oleophobic; ultrahydrophobic and/or ultraoleophobic; or superhydrophobic and/or superoleophobic by forming textured features in the silicon. Such a fixing member can be used as an oil-less fusing member for high speed, high quality electrophotographic printing to ensure and maintain a good toner release from the fused toner image on an image supporting material (e.g., a paper sheet), and further assist paper stripping. In another embodiment, the silicon textured surface can provide an oil-free, such as wax-free, toner design for the oil-less fixing process.

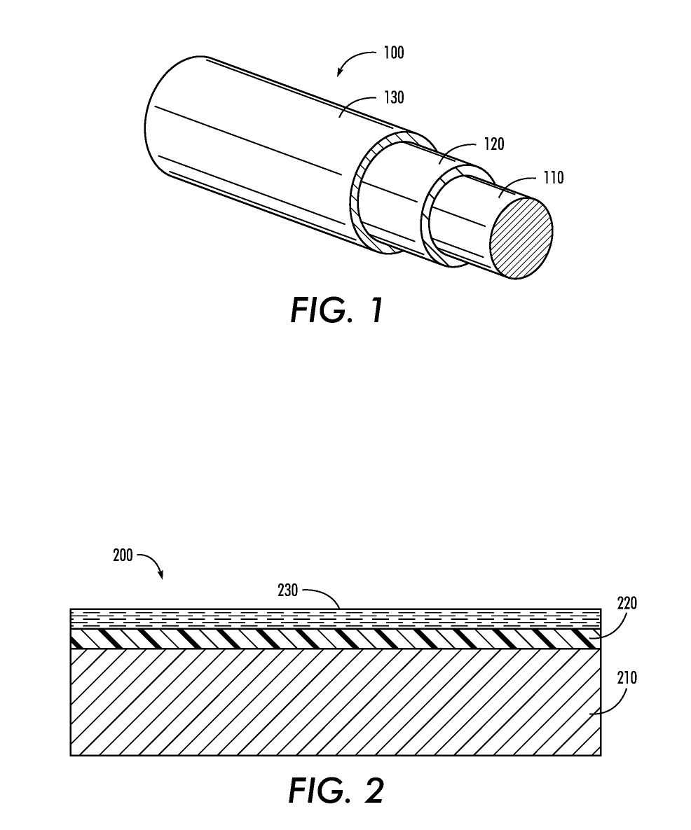

In various embodiments, the fixing member can include, for example, a substrate, with one or more functional layers formed thereon. The substrate can be formed in various shapes, e.g., a cylinder (e.g., a cylinder tube), a cylindrical drum, a belt, or a film, using suitable materials that are non-conductive or conductive depending on a specific configuration, for example, as shown in FIGS. 1 and 2.

Specifically, FIG. 1 depicts exemplary a fixing or fusing member 100 having a cylindrical substrate 110 and FIG. 2 depicts another exemplary fixing or fusing member 200 having a belt substrate 210 in accordance with the present teachings. It should be readily apparent to one of ordinary skill in the art that the fixing or fusing member 100 depicted in FIG. 1 and the fixing or fusing member 200 depicted in FIG. 2 represent generalized schematic illustrations and that other layers/substrates can be added or existing layers/substrates can be removed or modified.

In FIG. 1 the exemplary fixing member 100 can be a fuser roller having a cylindrical substrate 110 with one or more functional layers 120 and an outer layer 130 formed thereon. In various embodiments, the cylindrical substrate 110 can take the form of a cylindrical tube, e.g., having a hollow structure including a heating lamp therein, or a solid cylindrical shaft. In FIG. 2, the exemplary fixing member 200 can include a belt substrate 210 with one or more functional layers, e.g., 220 and an outer surface 230 formed thereon. The belt substrate 210 and the cylindrical substrate 110 can be formed from, for example, polymeric materials (e.g., polyimide, polyaramide, polyether ether ketone, polyetherimide, polyphthalamide, polyamide-imide, polyketone, polyphenylene sulfide, fluoropolyimides or fluoropolyurethanes), metal materials (e.g., aluminum or stainless steel) to maintain rigidity and structural integrity as known to one of ordinary skill in the art.

Examples of functional layers 120 and 220 include fluorosilicones, silicone rubbers such as room temperature vulcanization (RTV) silicone rubbers, high temperature vulcanization (HTV) silicone rubbers, and low temperature vulcanization (LTV) silicone rubbers. These rubbers are known and readily available commercially, such as SILASTIC® 735 black RTV and SILASTIC® 732 RTV, both from Dow Corning; 106 RTV Silicone Rubber and 90 RTV Silicone Rubber, both from General Electric; and JCR6115CLEAR HTV and SE4705U HTV silicone rubbers from Dow Corning Toray Silicones. Other suitable silicone materials include the siloxanes (such as polydimethylsiloxanes); fluorosilicones such as Silicone Rubber 552, available from Sampson Coatings, Richmond, Va.; liquid silicone rubbers such as vinyl crosslinked heat curable rubbers or silanol room temperature crosslinked materials; and the like. Another specific example is Dow Corning Sylgard 182. Commercially available LSR rubbers include Dow Corning Q3-6395, Q3-6396, SILASTIC® 590 LSR, SILASTIC® 591 LSR, SILASTIC® 595 LSR, SILASTIC® 596 LSR, and SILASTIC® 598 LSR from Dow Corning. The functional layers provide elasticity and can be mixed with inorganic particles, for example SiC or Al₂O₃, as required.

Examples of functional layers 120 and 220 also include fluoroelastomers. Fluoroelastomers are from the class of 1) copolymers of two of vinylidenefluoride, hexafluoropropylene, and tetrafluoroethylene; 2) terpolymers of vinylidenefluoride, hexafluoropropylene, and tetrafluoroethylene; and 3) tetrapolymer's of vinylidenefluoride, hexafluoropropylene, tetrafluoroethylene, and cure site monomer. These fluoroelastomers are known commercially under various designations such as VITON A®, VITON B®, VITON E®, VITON E 60C®, VITON E430®, VITON 910®, VITON GH®; VITON GF®; and VITON ETP®. The VITON® designation is a Trademark of E.I. DuPont de Nemours, Inc. The cure site monomer can be 4-bromoperfluorobutene-1,1,1-dihydro-4-bromoperfluorobutene-1,3-bromoperfluoropropene-1,1,1-dihydro-3-bromoperfluoropropene-1, or any other suitable, known cure site monomer, such as those commercially available from DuPont. Other commercially available fluoropolymers include FLUOREL 2170°, FLUOREL 2174®, FLUOREL 2176®, FLUOREL 2177® and FLUOREL LVS 76®, FLUOREL® being a registered trademark of 3M Company. Additional commercially available materials include AFLAS™ a poly(propylene-tetrafluoroethylene) and FLUOREL II® (LII900) a poly(propylene-tetrafluoroethylenevinylidenefluoride) both also available from 3M Company, as well as the Tecnoflons identified as FOR-60KIR®, FOR-LHF®, NM® FOR-THF®, FOR-TFS®, TH®, NH®, P757®, TNS®, T439®, PL958®, BR9151® and TN505®, available from Ausimont.

Examples of three known fluoroelastomers are (1) a class of copolymers of two of vinylidenefluoride, hexafluoropropylene, and tetrafluoroethylene, such as those known commercially as VITON A®; (2) a class Of terpolymers of vinylidenefluoride, hexafluoropropylene, and tetrafluoroethylene known commercially as VITON B®; and (3) a class of tetrapolymers of vinylidenefluoride, hexafluoropropylene, tetrafluoroethylene, and cure site monomer known commercially as VITON GH® or VITON GF®.

The fluoroelastomers VITON GH® and VITON GF® have relatively low amounts of vinylidenefluoride. The VITON GF® and VITON GH® have about 35 weight percent of vinylidenefluoride, about 34 weight percent of hexafluoropropylene, and about 29 weight percent of tetrafluoroethylene, with about 2 weight percent cure site monomer.

For a roller configuration, the thickness of the functional layer can be from about 0.5 mm to about 10 mm, or from about 1 mm to about 8 mm, or from about 2 mm to about 7 mm. For a belt configuration, the functional layer can be from about 25 microns up to about 2 mm, or from 40 microns to about 1.5 mm, or from 50 microns to about 1 mm.

An exemplary embodiment of a release layer 130 or 230 includes fluoropolymer particles. Fluoropolymer particles suitable for use in the formulation described herein include fluorine-containing polymers. These polymers include fluoropolymers comprising a monomeric repeat unit that is selected from the group consisting of vinylidene fluoride, hexafluoropropylene, tetrafluoroethylene, perfluoroalkylvinylether, and mixtures thereof. The fluoropolymers may include linear or branched polymers, and cross-linked fluoroelastomers. Examples of fluoropolymer include polytetrafluoroethylene (PTFE); perfluoroalkoxy polymer resin (PFA); copolymer of tetrafluoroethylene (TFE) and hexafluoropropylene (HFP); copolymers of hexafluoropropylene (HFP) and vinylidene fluoride (VDF or VF2); terpolymers of tetrafluoroethylene (TFE), vinylidene fluoride (VDF), and hexafluoropropylene (HFP); and tetrapolymers of tetrafluoroethylene (TFE), vinylidene fluoride (VF2), and hexafluoropropylene (HFP), and mixtures thereof. The fluoropolymer particles provide chemical and thermal stability and have a low surface energy. The fluoropolymer particles have a melting temperature of from about 255° C. to about 360° C. or from about 280° C. to about 330° C. These particles are melted to form the release layer.

For the fuser member 200, the thickness of the outer surface layer or release layer 230 can be from about 10 microns to about 100 microns, or from about 20 microns to about 80 microns, or from about 40 microns to about 60 microns.

Additives and additional conductive or non-conductive fillers may be present in the intermediate layer substrate layers 110 and 210, the intermediate layers 220 and 230 and the release layers 130 and 230. In various embodiments, other filler materials or additives including, for example, inorganic particles, can be used for the coating composition and the subsequently formed surface layer. Conductive fillers used herein may include carbon blacks such as carbon black, graphite, fullerene, acetylene black, fluorinated carbon black, and the like; carbon nanotubes; metal oxides and doped metal oxides, such as tin oxide, antimony dioxide, antimony-doped tin oxide, titanium dioxide, indium oxide, zinc oxide, indium oxide, indium-doped tin trioxide, and the like; and mixtures thereof. Certain polymers such as polyanilines, polythiophenes, polyacetylene, poly(p-phenylene vinylene), poly(p-phenylene sulfide), pyrroles, polyindole, polypyrene, polycarbazole, polyazulene, polyazepine, poly(fluorine), polynaphthalene, salts of organic sulfonic acid, esters of phosphoric acid, esters of fatty acids, ammonium or phosphonium salts and mixtures thereof can be used as conductive fillers. In various embodiments, other additives known to one of ordinary skill in the art can also be included to form the disclosed composite materials.

Optionally, any known and available suitable adhesive layer may be positioned between the outer layer or outer surface, the functional layer and the substrate. The adhesive layer can be coated on the substrate, or on the outer layer, to a thickness of from about 2 nanometers to about 10,000 nanometers, or from about 2 nanometers to about 1,000 nanometers, or from about 2 nanometers to about 5000 nanometers. The adhesive can be coated by any suitable known technique, including spray coating or wiping.

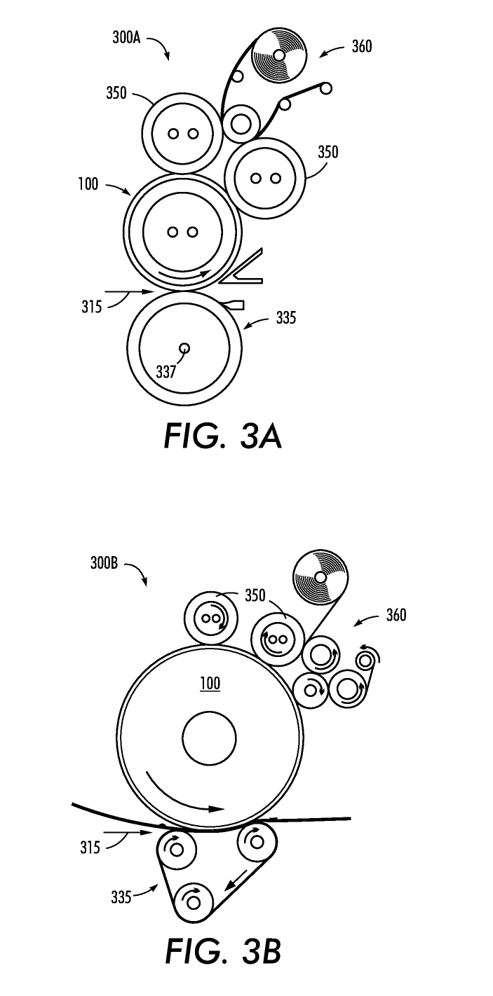

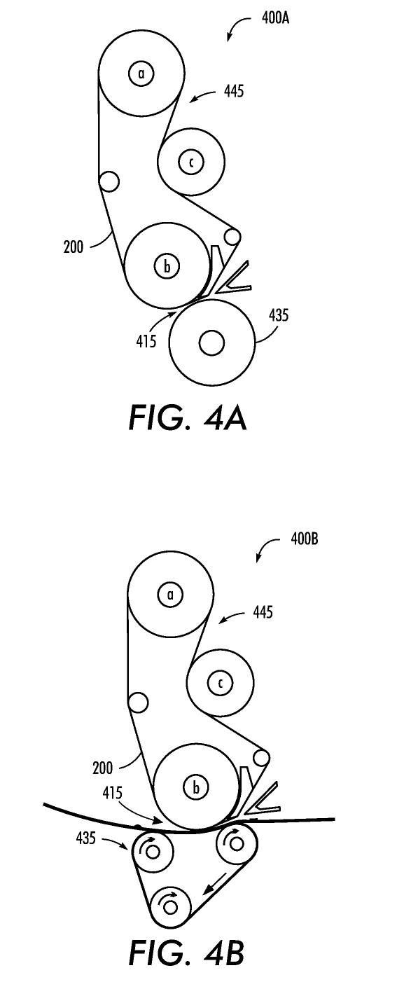

FIGS. 3A-4B and FIGS. 4A-4B depict exemplary fusing configurations for the fusing process in accordance with the present teachings. It should be readily apparent to one of ordinary skill in the art that the fusing configurations 300A-B depicted in FIGS. 3A-3B and the fusing configurations 400A-B depicted in FIGS. 4A-4B represent generalized schematic illustrations and that other members/layers/substrates/configurations can be added or existing members/layers/substrates/configurations can be removed or modified. Although an electrophotographic printer is described herein, the disclosed apparatus and method can be applied to other printing technologies. Examples include offset printing and inkjet and solid transfix machines.

FIGS. 3A-3B depict the fusing configurations 300A-B using a fuser roller shown in FIG. 1 in accordance with the present teachings. The configurations 300A-B can include a fuser roller 100 (i.e., 100 of FIG. 1) that forms a fuser nip with a pressure applying mechanism 335, such as a pressure roller in FIG. 3A or a pressure belt in FIG. 3B, for an image supporting material 315. In various embodiments, the pressure applying mechanism 335 can be used in combination with a heat lamp 337 to provide both the pressure and heat for the fusing process of the toner particles on the image supporting material 315. In addition, the configurations 300A-B can include one or more external heat roller 350 along with, e.g., a cleaning web 360, as shown in FIG. 3A and FIG. 3B.

FIGS. 4A-4B depict fusing configurations 400A-B using a fuser belt shown in FIG. 2 in accordance with the present teachings. The configurations 400A-B can include a fuser belt 200 (i.e., 200 of FIG. 2) that forms a fuser nip with a pressure applying mechanism 435, such as a pressure roller in FIG. 4A or a pressure belt in FIG. 4B, for a media substrate 415. In various embodiments, the pressure applying mechanism 435 can be used in a combination with a heat lamp to provide both the pressure and heat for the fusing process of the toner particles on the media substrate 415. In addition, the configurations 400A-B can include a mechanical system 445 to move the fuser belt 200 and thus fusing the toner particles and forming images on the media substrate 415. The mechanical system 445 can include one or more rollers 445a-c, which can also be used as heat rollers when needed.

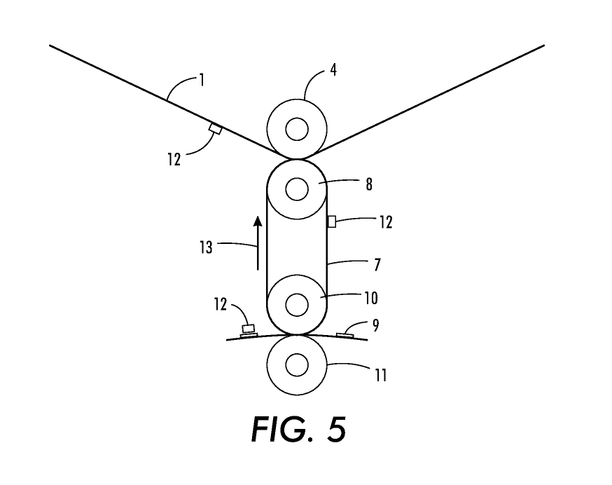

FIG. 5 demonstrates a view of an embodiment of a transfix member 7 which may be in the form of a belt, sheet, film, or like form. The transfix member 7 is constructed similarly to the fuser belt 200 described above. The developed image 12 positioned on intermediate transfer member 1 is brought into contact with and transferred to transfix member 7 via rollers 4 and 8. Roller 4 and/or roller 8 may or may not have heat associated therewith. Transfix member 7 proceeds in the direction of arrow 13. The developed image is transferred and fused to a copy substrate 9 as copy substrate 9 is advanced between rollers 10 and 11. Rollers 10 and/or 11 may or may not have heat associated therewith.

Disclosed herein is fuser member that includes a siloxyfluorocarbon networked polymer in any of the above described layers. The siloxyfluorcarbon networked polymer is formed via sol-gel chemistry. Siloxyfluorocarbon monomers are crosslinked via sol-gel chemistry, where hydrolysis and condensation of alkoxide or hydroxide groups occurs and upon curing at elevated temperatures, produces a coating used on fusing surfaces. The siloxyfluorocarbon networked polymer can be present in one or more of the intermediate layer, the outer layer, or the adhesive layer. The siloxyfluorocarbon networked polymer can withstand high temperature conditions without melting or degradation, is mechanically robust under fusing conditions, and displays good release under fusing conditions. The siloxyfluorocarbon (SFC) networked polymer is well suited to serve as an adhesive layer for fuser rollers or belts. A SFC networked polymer layer binds together the silicone rubber and the fusing topcoat. Using SFC as an adhesive layer decreases the occurrence of failure due to delamination, and suppresses defects occurring during processing by forming a networked, reinforcing layer around the silicone rubber.

Monofunctional, difunctional, or trifunctional silane end groups may be used to prepare a siloxyfluorocarbon networked polymer. Siloxyfluorocarbon monomers are represented by the structure:

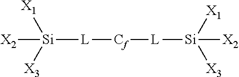

wherein C_{f} is an aliphatic or aromatic fluorocarbon chain; L is a CₙH₂ₙ linker group, where n is a number between 0 and about 10; and X₁, X₂, and X₃ are reactive hydroxide functionalities, reactive alkoxide functionalities, unreactive aliphatic functionalities of about 1 carbon atom to about 10 carbon atoms, unreactive aromatic functionalities of about 1 carbon atom to 10 carbon atoms.

In addition to the monomers listed above, the siloxyfluorocarbon networked polymer can be prepared using monomers having the following structure:

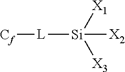

wherein C_{f} represents a fluorocarbon chain, which may be aliphatic, aromatic, or contain mixtures of aliphatic or aromatic fluorocarbon chains; L is a CₙH₂ₙ linker group, where n is a number between 0 and about 10 (most likely 0 to 2); X₁, X₂, and X₃ may be reactive hydroxide or alkoxide functionalities, or unreactive functionalities (aliphatic or aromatic hydrocarbons).

In addition to the monomers listed above, the siloxyfluorocarbon networked polymer can be prepared using monomers that include non-fluorinated silane monomers selected from the group consisting of silicon tetraalkoxide and branched pentasilylchloride. The silicon tetraalkoxide and branched pentasilylchloride are represented by the respective structures;

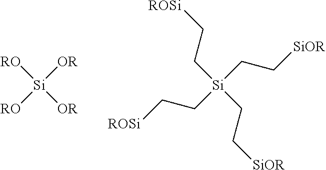

The siloxyfluorocarbon networked polymer comprises a fluorine content of between about 30 weight percent to about 70 weight percent or from about 40 weight percent to about 70 weight percent or from about 50 weight percent to about 70 weight percent. The silicon content, by weight, in the siloxyfluorocarbon networked polymer is from about 1 weight percent silicon to about 20 weight percent silicon, or from about 1.5 weight percent silicon to about 15 weight percent silicon or from about 2 weight percent silicon to about 10 weight percent silicon.

The monomers are networked together so that all monomers are molecularly bonded together in the cured coating via silicon oxide (Si—O—Si) linkages. Therefore, a molecular weight can not be given for the siloxyfluorocarbon networked polymer because the coating is crosslinked into one system.

Solvents used for sol gel processing of siloxyfluorocarbon precursors and coating of layers include organic hydrocarbon solvents, and fluorinated solvents. Alcohols such as methanol, ethanol, and isopropanol are typically used to promote sol gel reactions in solution. Further examples of solvents include ketones such as methyl ethyl ketone, and methyl isobutyl ketone. Mixtures of solvents may be used. The solvent system included the addition of a small portion of water, such as from about 1 molar equivalent to 10 molar equivalents of water compared to siloxyfluorocarbon precursors or the siloxane terminated fluorocarbons, or from about 2 molar equivalents to about 4 molar equivalents of water.

Upon the addition of water to the solution of sol gel precursors, alkoxy groups react with water, and condense to form agglomerates that are partially networked, and are referred to as a sol. Upon coating of the partially networked sol onto a substrate, a gel is formed upon drying, and with subsequent heat treatment, the fully networked SFC coating (siloxyfluorocarbon networked polymer) is formed on the substrate surface (fuser substrate).

A siloxyfluorocarbon networked polymer does not dissolve when exposed to solvents (such as ketones, chlorinated solvents, ethers etc.) and does not degrade at temperatures up to 350° C., and is stable at higher temperatures, depending on the system. The siloxyfluorocrbon networked polymer exhibits good release when exposed to toner or other contaminants, so that toner and other printing-related materials do not adhere to the fusing member.

Ceramic materials are well-known for their strength and durability; however, they tend to be non-elastic and brittle. Therefore, ceramics alone are not ideal for use as a fusing material. The use of metal alkoxide sol-gel components allows the chemical incorporation of ceramic domains into a hybrid system. It is desirable to couple sol-gel components with fluorocarbon chains both to introduce flexibility into the system, as well as to keep the fluorination content high for good release.

In an embodiment, one can use metal alkoxide (M=Si, Al, Ti etc.) functionalities as cross-linking components between fluorocarbon chains. For cross-linking to occur efficiently throughout the composite, bifunctional fluorocarbon chains are used. Mono-functional fluorocarbon chains can also be added to enrich fluorination content. CF₃-terminated chains align at the fusing surface to reduce surface energy and improve release.

Examples of precursors that may be used to form a composite system include silicon tetraalkoxide and siloxane-terminated fluorocarbon chains and are shown below. Siloxane-based sol-gel precursors are commercially available. The addition of a silicon tetraalkoxide (such as a silicon tetraalkoxide, below) introduces extra cross-linking and robustness to the material, but is not necessary to form the sol-gel/fluorocarbon composite system.

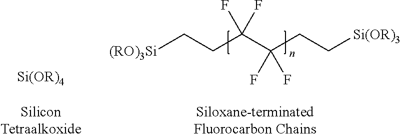

Fluorocarbon chains include readily available dialkene precursors which can then be converted to silanes via hydrosilation (Reaction 1). Monofunctional fluorinated siloxane chains are commercially available as methyl or ethyl siloxanes, or could be converted from chlorosilane or dialkene precursors.

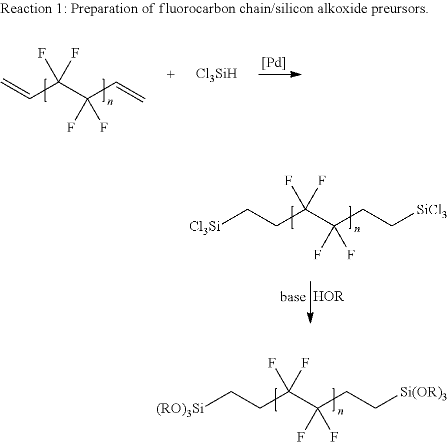

Shown below are some fluorinated and siloxane precursors that are commercially available. Fluorocarbon and siloxane materials are available from a variety of vendors including Gelest, Synquest, Apollo Scientific, Fluorochem, TCI America, Anachemica, Lancaster Synthesis Inc., and Polysciences Inc.

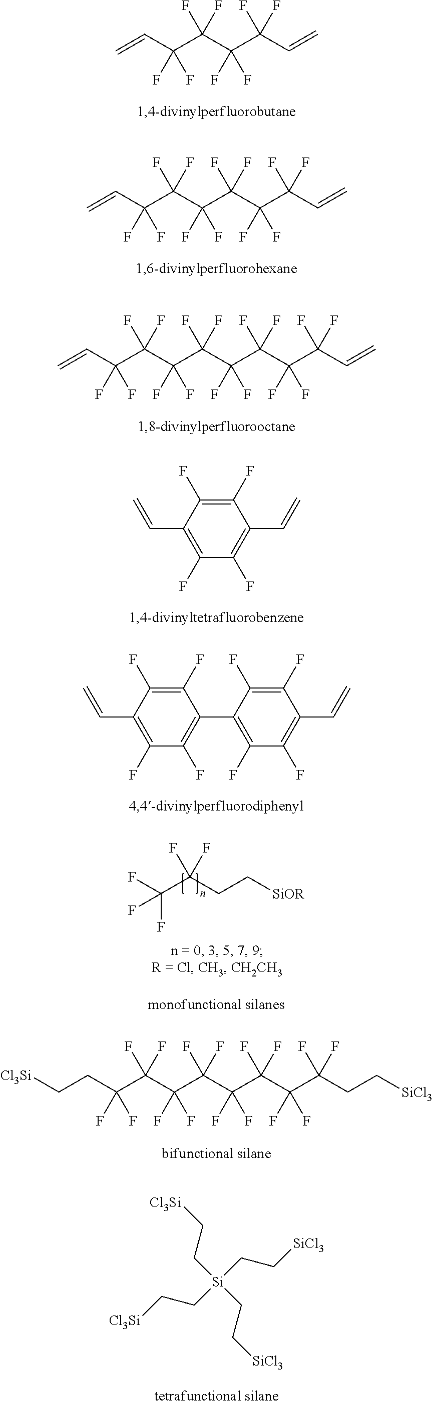

A representation of an example of a crosslinked composite system incorporating both monofunctional and difunctional fluorinated siloxane chains is shown in Structure 1. In this example, mechanical properties and fluorination content can be modified by adjustment of the ratio of mono- to difunctional precursors.

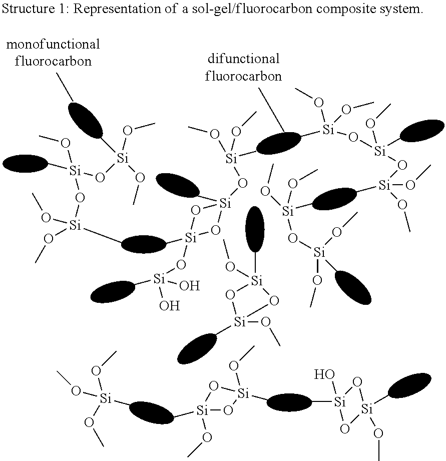

Organic-inorganic hybrid materials have been prepared for flexible optical waveguide applications using a trifunctional siloxane group, and fluorinated bis-phenol-A, described in J. Mater. Chem. 2008, 18, 579-585. The resulting materials were reported to be hard, yet flexible, and crack-free. Hybrid materials of this type are often cited for optical waveguide applications due to desirable refractive index properties of fluorinated materials combined with the mechanical strength of ceramics. However, these materials are not suitable for fuser applications where mechanical strength, flexibility and low surface energy are required.

### EXAMPLES

### Siloxyfluorocarbon Networked Polymer: Disiloxyperfluorohexane Topcoat on Silicone Substrate

A coating of siloxyfluorocarbon networked polymer was applied directly over a silicone rubber substrate without a primer. The structure of the disiloxyperfluorohexane (SFC) is shown below.

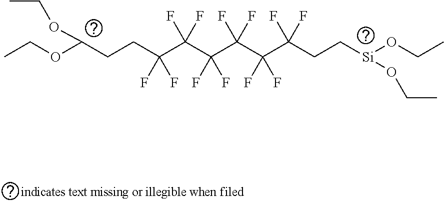

The topcoat layer solution was prepared with 2 grams SFC dissolved in 12 mL of ethanol (0.268 M concentration), with the addition of 0.174 grams H₂O and 7 mgrams NaOH.

In a flow coating process, one pass of the SFC topcoat layer solution was added to a bare Olympia roller and allowed to air-dry. Heat treatment was carried out to 218° C. to ensure networking of the topcoat layer,

The outer SFC topcoat could not be scraped away with a spatula or peeled from the surface of the silicone rubber. In comparison, a PFA topcoat of an Olympia control roller with primer can be peeled from the silicone substrate. In addition, pressing with a spatula or a hard tip did not result in a compressed area to the extent that is observed for a PFA topcoat, and simulates surface damage that may occur during handling. Fusing studies carried out with the SFC topcoat show that toner release occurs with wax-containing toner and without requiring the aid of an oil barrier between the topcoat layer and toner/paper surface.

A proportion of siloxy functionalities are bonded within the siloxyfluorocarbon networked polymer and can be additionally bonded to other fusing layer to the extent to allow for release with toner, and remaining siloxy functionalities are present to a small extent that does not result in surface contamination.

Fusing measures such as cold offset temperature and hot offset temperature are influenced by the fluorocarbon chain length and the fluorine content of the siloxyfluorocarbon topcoat. Hot offset temperature is increased with increasing n of (CF₂)ₙ fluorocarbon chain incorporated into the SFC networked polymer.

Siloxyfluorocarbon Networked Polymer: Disiloxyperfluorohexane Primer Layer with PFA Teflon Topcoat

A coating of perfluoroalkoxy polymer resin (PFA) with 10 weight percent of siloxyfluorocarbon networked polymer was applied over a primer layer composed of siloxyfluorocarbon networked polymer. The structure of the disiloxyperfluorohexane (SFC) is shown below.

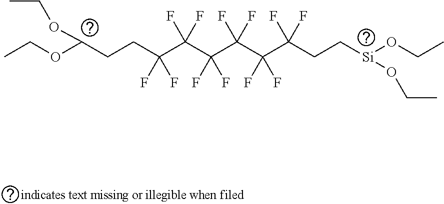

The primer layer solution was prepared with 1.17 grams SFC dissolved in 7 mL of ethanol (0.268 M concentration), with the addition of 0.102 grams H₂O and 4 mgram NaOH. The PFA topcoat dispersion was prepared from 2.16 grams PFA and 8.64 grams ethanol that was stirred vigorously, and 1.2 mL primer solution was added to yield 10 weight percent SFC content in the PFA topcoat dispersion.

In a flow coating process, one pass of the primer layer solution was added to a bare Olympia roller and allowed to air-dry. Immediately following, 4 successive passes of PFA topcoat dispersion were applied to the surface with 5 minutes between passes. Heat treatment was carried out to 218° C. to ensure networking of the primer layer, followed by heat treated in a 350° C. oven for 15 minute to cure the PFA topcoat.

The outer PFA coating could not be scraped away with a spatula or peeled from the surface of the silicone rubber. In comparison, the PFA topcoat of an Olympia control roller with primer can be peeled from the silicone substrate. Cracking of the outer PFA topcoat was not observed.

The PFA with 10 weight percent SFC topcoat would not adhere as strongly to the silicone rubber without the addition of the SFC primer layer. It has been demonstrated that a composite coating of 25 weight percent SFC/75 weight percent PFA can be peeled away from a silicone substrate by force. The addition of the SFC primer layer with PFA containing only 10 weight percent SFC produced a strongly bound topcoat.

In order to enhance adhesion to the primer layer, a small amount of SFC networked polymer may be added to the topcoat formulation. SFC may be added in the range of about 0.1 weight percent to about 10 weight percent, or from about 1 weight percent to about 5 weight percent, or about 2 weight percent to about 4 weight percent. The surface energy of flow-coated SFC (disiloxyperfluorohexane), shown in Table 1, is comparable to that of Viton and should not affect toner release in small amounts.

TABLE 1
Calculated surface energy of SFC compared with Teflon and Viton

| | Surface Energy (mN/m²) |
|---|---|
| | (Calculated from contact angles of water, |
| Sample | formamide, diiodomethane) |
| Teflon Topcoat (PFA) | 19.75 |
| SFC Flowcoat | 23.46 |
| Viton | 22.93 |

Application of the adhesive layer may be carried out by spray-coating, flow-coating, or by other coating methods. Typically, a solution of SFC material in ethanol or another alcohol or mixture containing alcohol can be prepared with the addition of 3-4 equivalents of water and a catalytic amount of acid or base to initiate networking. Following air-drying, the topcoat layer can be applied. The SFC primer layer can fully network and adhere to both silicone and the topcoat layer with heat treatment.

It will be appreciated that variants of the above-disclosed and other features and functions or alternatives thereof may be combined into other different systems or applications. Various presently unforeseen or unanticipated alternatives, modifications, variations, or improvements therein may be subsequently made by those skilled in the art, which are also encompassed by the following claims.

What is claimed is:

1. A fuser member comprising a layer of a siloxyfluorocarbon networked polymer.

2. The fuser member of claim 1 wherein the siloxyfluorocarbon networked polymer is formed from siloxyfluorocarbon monomers represented by the structure: 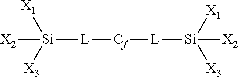
wherein C_{f} is an aliphatic or aromatic fluorocarbon chain; L is a CₙH₂ₙ linker group, where n is a number between 0 and about 10; and X₁, X₂, and X₃ are reactive hydroxide functionalities, reactive alkoxide functionalities, unreactive aliphatic functionalities of about 1 carbon atom to about 10 carbon atoms, unreactive aromatic functionalities of about 1 carbon atom to 10 carbon atoms.

3. The fuser member of claim 2 wherein the silane siloxyfluorocarbon monomers contain between about 5 carbon atoms to about 70 carbon atoms.

4. The fuser member of claim 2 wherein the siloxyfluorocarbon networked polymer comprises a fluorine content of between about 30 weight percent to about 70 weight percent.

5. The fuser member of claim 2 wherein the siloxyfluorocarbon monomers are selected from the group consisting of: 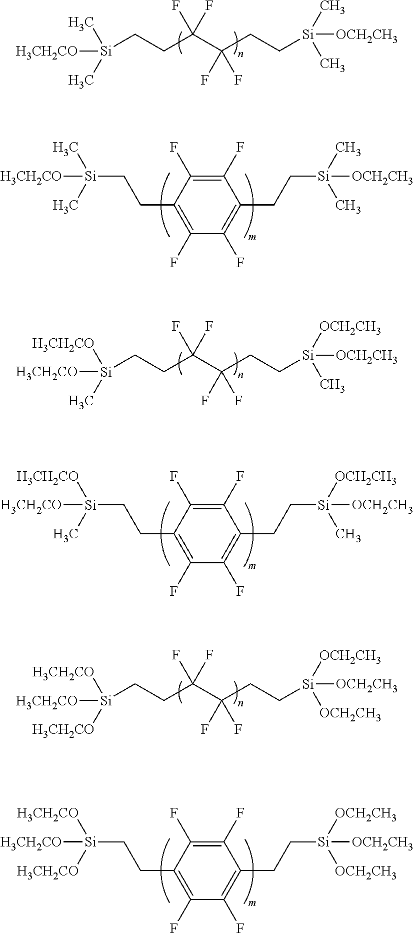
where n is a number between about 1 and about 20, and m is a number between about 1 and about 5.

6. The fuser member of claim 2 wherein the siloxyfluorocarbon monomers further comprise monomers comprising the structure: 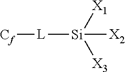
wherein C_{f} represents a fluorocarbon chain, which may be aliphatic, aromatic, or contain mixtures of aliphatic or aromatic fluorocarbon chains; L is a CₙH₂ₙ linker group, where n is a number between 0 and about 10; X₁, X₂, and X₃ are selected from the group consisting of reactive hydroxide functionalities, reactive alkoxide functionalities, unreactive aliphatic functionalities and unreactive aromatic functionalites.

7. The fuser member of claim 2 wherein the layer comprising a networked siloxyfluorocarbon polymer, further comprises non-fluorinated silane monomers selected from the group consisting of silicon tetraalkoxide and branched pentasilylchloride.

8. The fuser member of claim 7 wherein the silicon tetraalkoxide and branched pentasilylchloride are represented by the respective structures; 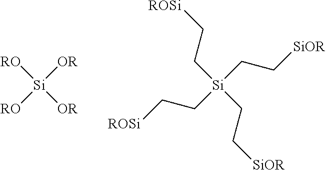
wherein R is an aliphatic or aromatic hydrocarbon chain of from about 1 to about 10 carbons.

9. A polymer comprising:
a siloxyfluorocarbon networked polymer having a fluorine content of between about 30 weight percent to about 70 weight percent.

10. The polymer of claim 9 formed by reacting in a solution of siloxane terminated fluorocarbons, and a solvent and to form the networked siloxyfluorocarbon wherein the siloxane terminated fluorocarbons are represented by the structure: 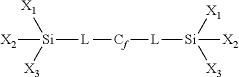
wherein C_{f} is an aliphatic or aromatic fluorocarbon chain; L is a CₙH₂ₙ linker group, where n is a number between 0 and about 10; and X₁, X₂, and X₃ are reactive hydroxide functionalities, reactive alkoxide functionalities, unreactive aliphatic functionalities of about 1 carbon atom to about 10 carbon atoms, unreactive aromatic functionalities of about 1 carbon atom to 10 carbon atoms.

11. The polymer of claim 10 wherein reacting the solution is at a temperature of from about 100° C. to about 250° C. for a time of from about 15 minutes to about 20 hours until there is no weight loss, and complete curing has occurred.

12. The polymer of claim 10 wherein the solvent is selected from the group consisting of alcohols, ketones, water and mixtures thereof.

13. The polymer of claim 12 wherein an amount of water is from about 1 to 10 molar equivalents of water to the siloxane terminated fluorocarbons.

14. A fuser member comprising:
a substrate;
a resilient layer disposed on the substrate;
an adhesive layer comprising a networked siloxyfluorocarbon polymer disposed on the resilient layer; and
a release layer comprising a fluoropolymer disposed on the adhesive layer.

15. The fuser member of claim 14 comprising a roller.

16. The fuser member of claim 14 comprising a belt.

17. The fuser member of claim 14 wherein the resilient layer comprises silicone.

18. The fuser member of claim 17 further wherein the resilient layer further comprises a networked siloxyfluorocarbon polymer.

19. The fuser member of claim 14 further wherein the release layer further comprises a networked siloxyfluorocarbon polymer.

20. The fuser member of claim 14 wherein the adhesive layer has a thickness of less than about 10 microns.
